(19) United States
(12) Patent Application Publication
(10) Pub. No.: US 2013/0171864 A1
(43) Pub. Date: Jul. 4, 2013

(54) CABLE WITH MULTIPLE, PHYSICALLY SELECTABLE CONNECTORS

(71) Applicant: Aviiq IP Inc, Hong Kong (CN)

(72) Inventors: Cezanne-Simon Farris-Gilbert, Long Beach, CA (US); Alan Chun-Ye Yeung, Santa Ana, CA (US)

(73) Assignee: AVIIQ IP INC, Hong Kong (CN)

(21) Appl. No.: 13/725,214

(22) Filed: Dec. 21, 2012

Related U.S. Application Data
(60) Provisional application No. 61/582,054, filed on Dec. 30, 2011.

(51) Int. Cl. H01R 13/58

(52) U.S. Cl. CPC H01R 13/58
USPC 439/445

(57) ABSTRACT

An electronic cable is provided. The electronic cable includes a cable extending between a first end and a second end. A first electronic connection extends from the first end of the cable. A plurality of physically selectable electronic connections extend from the second end of the cable.

### BACKGROUND

1. Technical Field

The present disclosure relates to electronic cables, and more particularly, to an electronic cable that includes multiple, physically selectable connectors on at least one end of the cable.

2. Description of the Related Art

It is common for electronic devices to come equipped with electronic connections designed according to industry standards to allow the interconnection of devices manufactured by different companies. However, even within these standards, there are numerous connector options. For example, within the Universal Serial Bus (USB) standard, there are numerous possible types of electronic connection configurations, including Standard-A, Standard-B, Mini-A, and Mini-B. With the multitude of electronic connector options, one may need many different cable options on hand in order to ensure that their electronic devices can be connected together.

Cables that include multiple electronic connection tips are known. However, these devices typically have a bulky configuration in which all of the tips are physically available for connection at the same time. Adapters which convert between a common connector type and a desired connector type are also known. One problem with known adaptors is that one would need to carry around a myriad of such adaptors in order to ensure that the appropriate connection can be obtained.

### BRIEF SUMMARY

An electronic cable that includes multiple, physically selectable electronic connections on one or both ends is provided.

In one embodiment, an electronic cable includes a cable, a first electronic connection on a first end of the cable, and a plurality of physically selectable electronic connections on a second end of the cable.

In another embodiment, an electronic cable includes a cable body, a first multi-plug holder positioned on a first end of the cable body, a first rotatably selectable multi-plug rotatably mounted in the first multi-plug holder, a second multi-plug holder positioned on a second end of the cable body, and a second rotatably selectable multi-plug rotatably mounted in the second multi-plug holder.

The first multi-plug holder includes a first contact set. The first rotatably selectable multi-plug includes a first head unit. The first head unit includes a first plurality of electronic connectors and a first plurality of contact sets. Each respective one of the first contact sets on the first head unit corresponds to a respective one of the first plurality of electronic connectors on the first head unit.

The second multi-plug holder includes a second contact set. The second rotatably selectable multi-plug includes a second head unit. The second head unit includes a second plurality of electronic connectors and a second plurality of contact sets. Each respective one of the second contact sets on the second head unit corresponds to a respective one of the second plurality of electronic connectors on the second head unit.

In another embodiment, an electronic cable includes a cable body that extends between a plug on one end of the cable body and a multi-plug on an opposite end of the cable body. The plug includes a first electronic connector. The multi-plug includes a plurality of electronic connectors that are fixed relative to the cable body. A knob is rotatably mounted on the multi-plug. The knob is configured to internally align a contact set with a selected one of the plurality of electronic connectors on the multi-plug to selectively form a circuit between a selected one of the plurality of electronic connectors on the multi-plug and the plug on the first electronic connector.

### BRIEF DESCRIPTION OF THE SEVERAL VIEWS OF THE DRAWINGS

FIG. 1 is an isometric view of an electronic cable, according to one embodiment, that includes multiple connectors on one end of the cable that are physically selectable by way of a rotatably selectable multi-plug;

FIG. 2 is a plan view of the electronic cable of FIG. 1;

FIG. 3 is a side view of the electronic cable of FIG. 1;

FIG. 4 is a plan view of another embodiment of an electronic cable that includes multiple, physically selectable connectors on one end;

FIG. 5 is a detail view of a rotatably selectable multi-plug of the electronic cable of FIG. 4;

FIG. 6 is a plan view of another embodiment of an electronic cable that includes multiple connectors on one end of the cable that are physically selectable by way of a rotatable knob; and

FIG. 7 is a plan view of another embodiment of an electronic cable that includes multiple, physically selectable connectors on opposite ends of the electronic cable.

### DETAILED DESCRIPTION

In one embodiment, shown in FIGS. 1-3, a cable 100 includes a single, non-changeable connector 10 on one end, and a head unit with multiple, individually selectable connectors 20, 30, and 40 on an opposite end. The design shown in FIGS. 1-3 allows the user to carry one cable in place of several different cables, preparing the user for many possible eventualities. By having physically selectable electronic connections, the size of the cable 100 is much smaller than conventional cables with multiple electronic connection tips that are maintained in their location at all times.

As shown in FIG. 1, the cable 100 includes a cable body 110 that extends between a plug 120 and a multi-plug holder 130. The cable body 110 may, or may not, conform to an industry standard, such as the Universal Serial Bus Specification Revision 2.0. For example, the cable body 110 may include a signal twisted pair, two conductors suitable for power (VBUS, GND), and an overall shield. Other cable configurations that conform to newer standards, such as the USB 3.0 Internal Connector and Cable Specification, are also within the scope of the present disclosure. The cable body 110 can be a flexible cable that gives a user a great degree of freedom to manipulate the cable 100 so as to accommodate a variety of relative positions of the devices that are being connected.

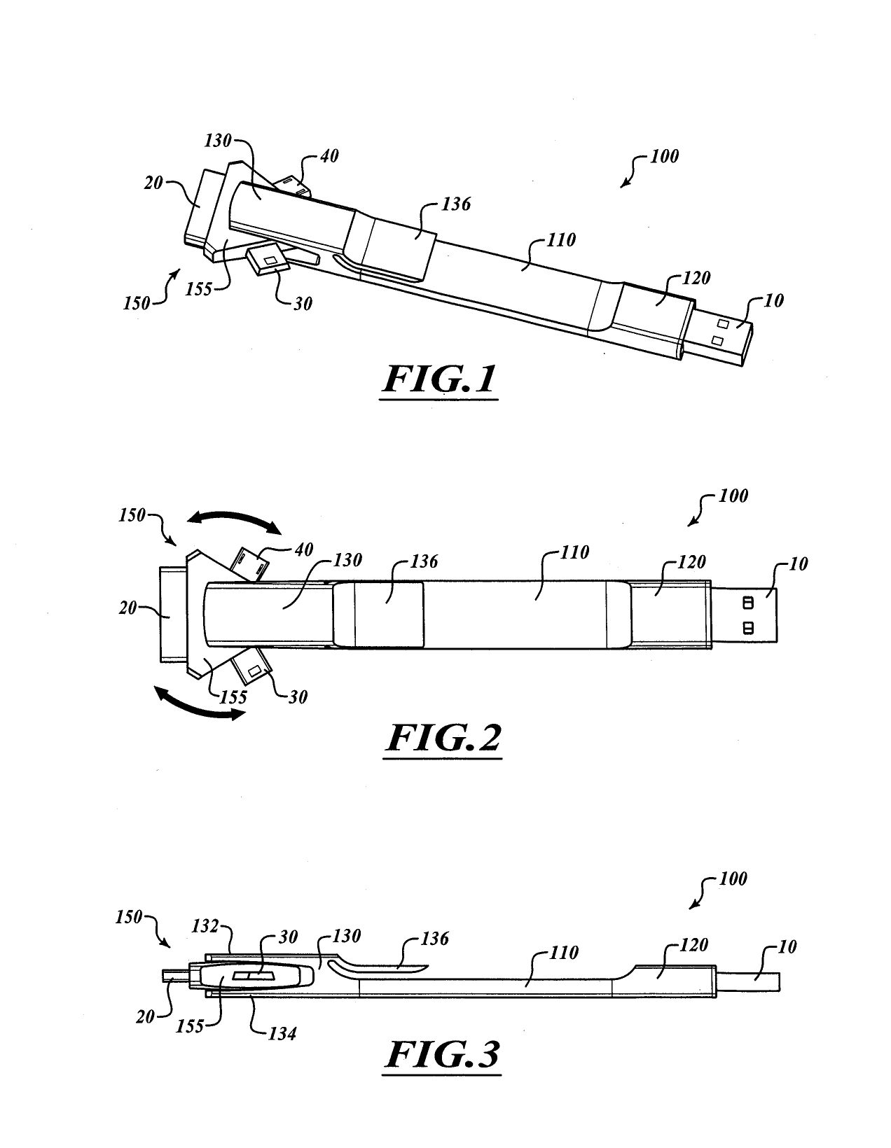

The plug 120 includes a standardized electronic connector 10. In this case, the electronic connector 10 is a USB-A male type connector. The opposite end of the cable 100 includes a rotatably selectable multi-plug 150 mounted within the multi-plug holder 130. The rotatably selectable multi-plug 150 includes three electronic connectors 20, 30, and 40 extending from a head unit 155. In the example illustrated in FIGS. 1-3, the electronic connector 20 is a 30-pin dock connector, the electronic connector 30 is a USB Mini-B male connector, and the electronic connector 40 is a USB Micro-B male connector. As shown in FIGS. 1 and 2, the electronic connector 10 is in line with the electronic connector 20, while the electronic connectors 30 and 40 are positioned in a storage position. The ability to place the non-selected connectors in a storage position allows the cable 100 to be more compact. The storage position may also make the non-selected connectors inaccessible for a reliable connection.

Although the rotatably selectable multi-plug 150 is depicted as including three different electronic connectors 20, 30, and 40, other configurations that include two or more different connectors are encompassed by the present disclosure. Further, the types of connectors are not limited to those illustrated in the embodiments shown in the Figures of the present disclosure. As will be readily apparent to one having ordinary skill in the art upon review of the entire disclosure, other types of connectors, both male and female connectors are possible and can be used by employing the appropriate cabling and connector contact sets. Further, the disclosure is not limited to connectors that conform to the Universal Serial Bus standard (USB standard).

As best seen in FIG. 3, the head unit 155 is secured between an upper retention arm 132 and a lower retention arm 134 of the multi-plug holder 130. The head unit 155 is mounted in the multi-plug holder 130 in a manner that allows the head unit 155 to rotate between three different selectable positions, and remain snapped in place at each one of the respective positions when selected. For example, the head unit 155 could include a post that is rotatably received in one or both of the upper and lower retention arms 132, 134 so as to be rotatable relative to the multi-plug holder 130. The multi-plug holder 130 can also include a detent mechanism that maintains the rotatably selectable multi-plug 150 in proper alignment with the multi-plug holder to allow easy access to the desired plug configuration. For example, an inner surface of one of the upper retention arm 132 and the lower retention arm 134 can include a hemispherical protrusion; and the head unit 155 can include three distinct recesses shaped to mate with the hemispherical protrusion when a respective one of the electronic connectors 20, 30, or 40 are in the desired alignment. In this embodiment, the upper retention arm 132 and the lower retention arm 134 can be made of a material that is flexible enough to allow the arms to deflect when the head unit 155 is rotated between desired connector positions.

In one example, the three electronic connectors 20, 30, and 40 have digitally selectable electrical connections with the electronic connector 10. Once the desired plug is physically selected by rotation of the head unit 155, the electrical connection between the electronic connector 10 and the selected connector is achieved merely by plugging in the selected connector to the desired device. For example, in the alignment shown in FIGS. 1 and 2, plugging in the electronic connectors 10 and 20 will result in these two connectors becoming active and electronic connectors 30 and 40 becoming inactive. With this configuration, the head unit 155 has a limited range of rotation relative to the multi-plug holder 130 in order to maintain the connection between each of the electronic connectors 20, 30, and 40 and the electronic connector 10. For example, the range of motion can be limited to anywhere from 240° to 270° of rotation.

The cable 100 can also include a clip 136 extending rearwardly from the multi-plug holder 130 over the cable body 110. As best shown in FIG. 3, the clip 136 can be spaced slightly above the cable body 110 and include a slight taper at a free end thereof. With this configuration, the cable 100 can be conveniently clipped to a belt or pocket of a user for easy access and transport.

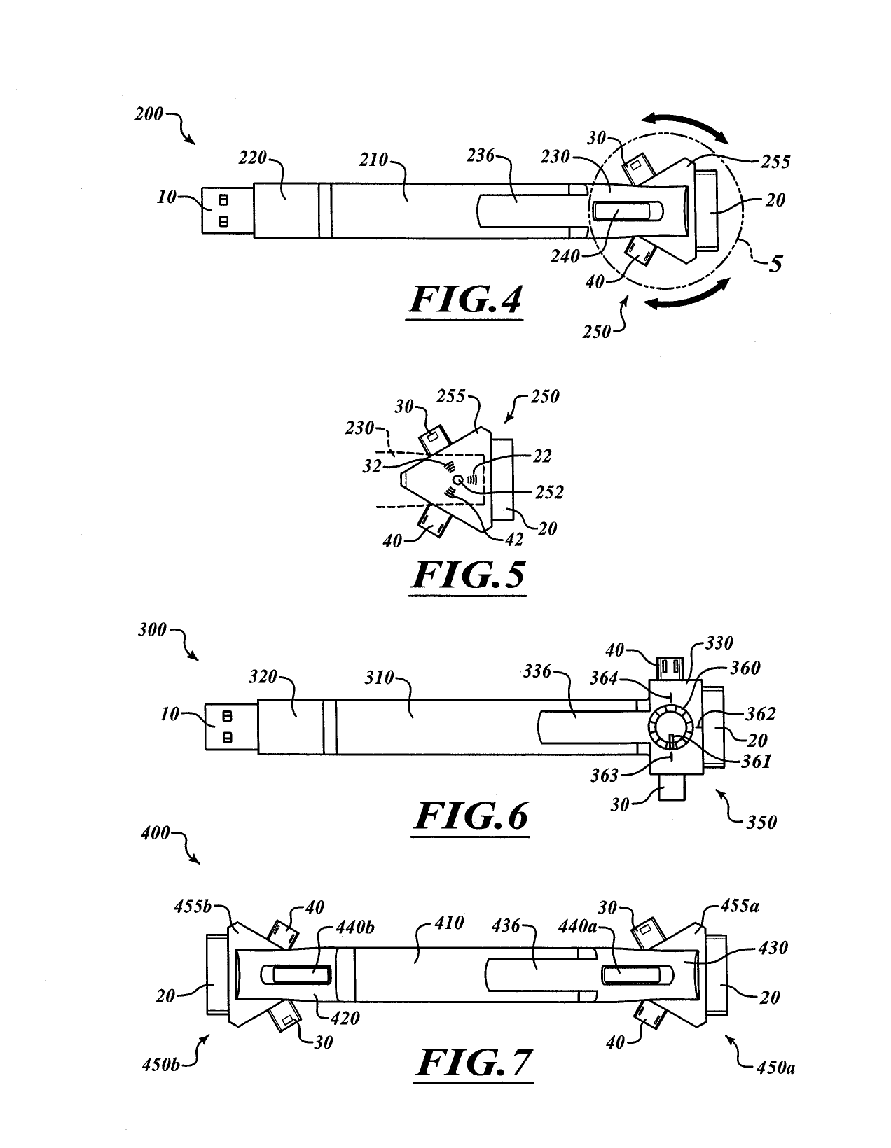

FIG. 4 illustrates a cable 200 according to another embodiment of the present disclosure. The cable 200 differs from the cable 100 in that the cable 200 includes a button 240.

As shown in FIG. 4, the cable 200 includes a cable body 210 that extends between a first end, which includes a plug 220 and a second end, which includes a multi-plug holder 230. The plug 220 includes an electronic connector 10, which is, in this embodiment, a USB-A male type connector. The rotatably selectable multi-plug 250 is placed inside a multi-plug holder 230. The rotatably selectable multi-plug 250 includes a head unit 255 and three electronic connectors 20, 30, and 40. In this embodiment, the electronic connector 20 is a 30-pin dock connector, the electronic connector 30 is a USB Mini-B male connector, and the electronic connector 40 is a USB Micro-B electronic connector.

A clip 236 extends rearwardly from the multi-plug holder 230 over the cable body 210 in a manner similar to the clip 136 described above with reference to FIGS. 1-3.

The embodiment in FIGS. 4 and 5 also differs from that in FIGS. 1-3 in that an electrical connection is made between a selected one of the electronic connectors 20, 30, and 40 and the electronic connector 10 by way of physical connections between contact sets rather than digitally selectable connections. As noted above, the cable 200 includes a button 240 which allows a user to lock or release the head unit 255. In one example, as shown in FIG. 5, the head unit 255 rotates about a pivot 252. The head unit 255 includes three contact sets 22, 32, and 42, which respectively correspond to the electronic connectors 20, 30, and 40. The multi-plug holder 230 includes a single contact set (not depicted). Actuation of the button 240 allows the rotatably selectable multi-plug 250 to spin relative to the multi-plug holder 230. Releasing the button 240 allows the rotatably selectable multi-plug 250 to snap into place when the contact set on the multi-plug holder 230 is aligned with a selected one of the contact sets on the head unit 255 so as to form a circuit between a selected one of the electronic connectors 20, 30, and 40 and the electronic connector 10 on the opposite end of the cable 200.

Rather than using contact sets to establish a connection, the embodiment in FIGS. 4 and 5 can also use digitally selectable electrical connections as described above with reference to FIGS. 1-3.

Likewise, the embodiment in FIGS. 1-3 can use a contact set configuration instead of the digitally selectable electrical connections. For example, the head unit 155 can include multiple contact sets which correspond to the number of connectors on a head unit 155. The multi-plug holder 130 can include a single contact set which faces the head unit 155. A user can form a circuit between the connector 10 on one end of the cable 100 and a selected one of the connectors 20, 30, and 40 on the opposite end of the cable by rotating the rotatably selectable multi-plug 150 relative to the multi-plug holder 130 so as to align a selected one of the contact sets on the head unit 155 with the contact set on the multi-plug holder 130. For example, as discussed above, the multi-plug holder 130 can include a detent mechanism that maintains the rotatably selectable multi-plug 150 in proper alignment with the multi-plug holder. The detent mechanism can help to maintain a reliable connection between a contact set on the multi-plug holder 130 and a selected contact set on the head unit 155.

FIG. 6 illustrates a cable 300 according to another embodiment of the present disclosure. The cable 300 includes a configuration in which one of several electronic connectors 20, 30, and 40 are selectable by actuation of a knob 360.

The cable 300 includes a cable body 310 that extends between a plug 320 on one end and a non-rotating head 350 that includes a multi-plug 330 on an opposite end. The plug 320 includes an electronic connector 10, which, in this embodiment, is a USB-A male type connector. The multiple-plug 330 includes three electronic connectors 20, 30, and 40. In this embodiment, the electronic connector 20 is a 30-pin dock connector, the electronic connector 30 is a USB Mini-B male type connector, and the electronic connector 40 is a USB Micro-B male connector. As with the previous embodiments, the cable 300 includes a clip 336, which facilitates easy transport of the cable 300.

Unlike the previous embodiments, the end of the cable 300 that includes multiple connectors, the non-rotating head 350, is fixed relative to the cable. In order to select a particular electronic connector, a user rotates a knob 360 which internally aligns a contact set with a selected one of the electronic connectors 20, 30, and 40. The knob 360 includes an indicator 361. The multi-plug 330 includes indication marks 362, 363, and 364 which respectively correspond to electronic connectors 20, 30, and 40. By aligning the selector indicator 361 with a desired one of the indications 362, 363, or 364, a user is able to selectively form a circuit between one of the electronic connectors 20, 30, and 40 and the electronic connector 10.

FIG. 7 illustrates a cable 400 according to another embodiment of the present disclosure. The cable 400 includes physically selectable multi-plug sets on both ends of the cable. The cable 400 includes a cable body 410 that extends between a first multi-plug holder 420 on one end and a second multi-plug holder 430 on the opposite end.

A rotatably selectable multi-plug 450a is rotatably supported in the second multi-plug holder 430, and a rotatably selectable multi-plug 450b is rotatably supported in the first multi-plug holder 420. The rotatably selectable multi-plug 450b includes a head unit 455b including electronic connectors 20, 30, and 40. The rotatably selectable multi-plug 450a includes a head unit 455a having electronic connectors 20, 30, and 40. The rotatably selectable multi-plugs 450a and 450b are either released or locked in place by actuation of a respective one of buttons 440a and 440b, in a manner similar to that discussed above with respect to the embodiment in FIGS. 4 and 5. It is also possible to use the detent mechanism described above with respect to the embodiment FIGS. 1-3 in place of one or both of the buttons 440a and 440b. As with the previous embodiments, the cable 400 includes a clip 436 which allows the cable to be mounted on a pocket or belt of a user. The configuration in FIG. 7 advantageously allows a user to switch between types of connections, or to change the gender of a connection from a female connection to a male connection by selecting the same type of electronic connector on each end of the cable 400. The cable 400 can use contact sets to establish a connection as described in the embodiment in FIGS. 4 and 5, can use digitally selectable electrical connections as described above with reference to FIGS. 1-3, or can use a combination of the two connection configurations.

Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic cable, comprising:
a cable;
a first electronic connection on a first end of the cable; and
a plurality of physically selectable electronic connections on a second end of the cable.

2. The electronic cable according to claim 1, further comprising a head unit rotatably mounted on the second end of the cable, the plurality of physically selectable electronic connections being positioned on the head unit.

3. The electronic cable according to claim 2, further comprising a holder positioned on the second end of the cable, the head unit being rotatably mounted in the holder.

4. The electronic cable according to claim 3, wherein the holder includes a first contact set, and the head unit includes a plurality of second contact sets, each of the plurality of second contact sets corresponding to a respective one of the plurality of electronic connections on the head unit.

5. The electronic cable according to claim 3, wherein the holder includes two arms, and the head unit is rotatably mounted between the two arms.

6. The electronic cable according to claim 3, wherein the holder includes a detent mechanism configured to maintain the head unit in non-rotating alignment with the holder so as to maintain a desired one of the plurality of physically selectable electronic connections in a desired orientation.

7. The electronic cable according to claim 3, wherein the holder includes a button configured to selectively place the head unit in a locked state or a released state, the head unit being able to spin relative to the holder in the released state, and the head unit being fixed relative to the holder in the locked state.

8. The electronic cable according to claim 1, further comprising a head unit rotatably mounted on the first end of the cable, a plurality of electronic connections being positioned on the head unit on the first end of the cable, the plurality of electronic connections on the head unit on the first end of the cable including the first electronic connection.

9. The electronic cable according to claim 1, wherein the first electronic connection is in electrical communication with the plurality of physically selectable electronic connections via digitally selectable electrical connections.

10. The electronic cable according to claim 1, further comprising a mechanical selector positioned on the second end of the cable.

11. The electronic cable according to claim 10, wherein the second end of the cable includes a plurality of indications, each of the indications corresponding to a respective one of the plurality of physically selectable electronic connections on the second end of the cable.

12. The electronic cable according to claim 11, wherein the mechanical selector is a switch rotatably mounted on the second end of the cable, the switch including an indicator, the switch being configured to selectively electronically connect one of the plurality of physically selectable electronic connections on the second end of the cable with the first electronic connection when the indicator on the switch is aligned with a selected one of the indications on the second end of the cable.

13. The electronic cable according to claim 1, wherein at least one of the first electronic connection and the plurality of physically selectable electronic connections is a male connection.

14. The electronic cable according to claim 13, wherein at least one of the first electronic connection and the plurality of physically selectable electronic connections is a female connection.

15. An electronic cable, comprising:
a cable body;
a first multi-plug holder positioned on a first end of the cable body, the first multi-plug holder including a first contact set;
a first rotatably selectable multi-plug rotatably mounted in the first multi-plug holder, the first rotatably selectable multi-plug including a first head unit, the first head unit including a first plurality of electronic connectors and a plurality of second contact sets, each respective one of the second contact sets on the first head unit corresponding to a respective one of the first plurality of electronic connectors on the first head unit;
a second multi-plug holder positioned on a second end of the cable body, the second multi-plug holder including a third contact set; and
a second rotatably selectable multi-plug rotatably mounted in the second multi-plug holder, the second rotatably selectable multi-plug including a second head unit, the second head unit including a second plurality of electronic connectors and a plurality of fourth contact sets, each respective one of the fourth contact sets on the second head unit corresponding to a respective one of the second plurality of electronic connectors on the second head unit.

16. The electronic cable according to claim 15, further comprising:
a first button positioned on the first multi-plug holder, the first button being configured to lock or release the first head unit to allow the first rotatably selectable multi-plug to spin relative to the first multi-plug holder when the first button is actuated, and to allow the first rotatably selectable multi-plug to snap into place when the first button is released and the first contact set on the first multi-plug holder is aligned with a selected one of the plurality of second contact sets on the on the first head unit; and
a second button positioned on the second multi-plug holder, the second button being configured to lock or release the second head unit to allow the second rotatably selectable multi-plug to spin relative to the second multi-plug holder when the second button is actuated, and to allow the second rotatably selectable multi-plug to snap into place when the second button is released and the third contact set on the second multi-plug holder is aligned with a selected one of the plurality of fourth contact sets on the on the second head unit.

17. The electronic cable according to claim 15, further comprising a clip extending rearwardly from a first end fixed to the first multi-plug holder to a free end over the cable body, the clip being offset from the cable body to define an open space between the clip and the cable body.

18. An electronic cable, comprising:
a cable body that extends between a plug on one end of the cable body and a multi-plug on an opposite end of the cable body, the plug including a first electronic connector, and the multi-plug including a plurality of electronic connectors that are fixed relative to the cable body; and
a knob rotatably mounted on the multi-plug, the knob being configured to internally align a contact set with a selected one of the plurality of electronic connectors on the multi-plug to selectively form a circuit between a selected one of the plurality of electronic connectors on the multi-plug and the plug on the first electronic connector.

19. The electronic cable according to claim 18, further comprising a clip extending rearwardly from a first end fixed to the multi-plug to a free end over the cable body, the clip being offset from the cable body to define an open space between the clip and the cable body.

20. The electronic cable according to claim 18, further comprising a clip extending rearwardly from a first end fixed to the one end of the cable body to a free end over the cable body, the clip being offset from the cable body to define an open space between the clip and the cable body.
